(19) United States
(12) Patent Application Publication
(10) Pub. No.: US 2025/0164848 A1
(43) Pub. Date: May 22, 2025

(54) DISPLAY PANEL, METHOD FOR MANUFACTURING DISPLAY PANEL, AND DISPLAY DEVICE

(71) Applicant: HKC CORPORATION LIMITED, Shenzhen (CN)

(72) Inventors: JUNHONG CAO, Shenzhen (CN); Haijiang YUAN, Shenzhen (CN)

(21) Appl. No.: 18/950,233

(22) Filed: Nov. 18, 2024

(30) Foreign Application Priority Data
Nov. 20, 2023 (CN) 202311541151.3

(51) Int. Cl. G02F 1/16757; G02F 1/1368; G02F 1/167; G02F 1/16766

(52) U.S. Cl. CPC G02F 1/16757; G02F 1/1368; G02F 1/167; G02F 1/16766

(57) ABSTRACT

A display panel includes a first substrate, an active switch layer, an electrophoretic layer, and a second substrate which are arranged in sequence. The electrophoretic layer is arranged between the first substrate and the second substrate. The active switch layer is arranged on the first substrate. The electrophoretic layer includes multiple first microcapsules and multiple columns. An interior of each first microcapsule is hollow and filled with electrophoretic particles. An interior of each column is hollow and filled with electrophoretic particles. The first microcapsules are each spherical. The multiple first microcapsules are arranged in a matrix. A capsule gap is formed between every four adjacent first microcapsules, and the respective column is disposed in the capsule gap. A direction pointing from the first substrate toward the second substrate is a first direction, and a height direction of the column is consistent with the first direction.

### CROSS-REFERENCE TO RELATED APPLICATIONS

This application claims the priority and benefit of Chinese patent application number 2023115411513, titled “Display Panel, Method for Manufacturing Display Panel, and Display Device” and filed Nov. 20, 2023 with China National Intellectual Property Administration, the entire contents of which are incorporated herein by reference.

### TECHNICAL FIELD

This application relates to the field of display technology, and more particularly relates to a display panel, a method for manufacturing a display panel, and a display device.

### BACKGROUND

The description provided in this section is intended for the mere purpose of providing background information related to the present application but doesn't necessarily constitute prior art.

With the development of digital technology, more and more display devices have entered people's lives, such as electronic paper display panels. As a new type of display device, electronic paper display panels are mainly used for display in electronic signage, billboards, and electronic readers, and have the advantages of capability of repeated rewriting, low power consumption, and wide viewing angle. However, since the current electronic paper display devices belong to the reflective display principle, when the external brightness is low, the brightness of the electronic paper display panel will also be low, thus affecting its display effect.

In particular, when using microcapsule-type electronic paper display panel technology, since the microcapsules are spherical and spread between two substrates, a capsule gap may appear between four adjacent microcapsules. The capsule gap area does not have a reflective function, which leads to a decrease in the brightness of the electronic paper display panel.

### SUMMARY

It is therefore one purpose of the present application to provide a display panel, a method for manufacturing a display panel, and a display device, so as to increase the display brightness of the display panel and improve the display effect.

The present application discloses a display panel. The display panel includes a first substrate, an active switch layer, an electrophoretic layer, and a second substrate arranged in sequence. The electrophoretic layer is arranged between the first substrate and the second substrate. The active switch layer is arranged on the first substrate. The electrophoretic layer includes a plurality of first microcapsules and a plurality of columns. The hollow space inside the first microcapsule is filled with electrophoretic particles. The hollow space inside the column is filled with electrophoretic particles. The first microcapsules are spherical. The plurality of first microcapsules are arranged in a matrix, and a capsule gap is formed between four adjacent first microcapsules. The column is located in the capsule gap. The direction from the first substrate toward the second substrate is a first direction, and the height direction of the column is consistent with the first direction.

In some embodiments, the side of the second substrate facing away from the first substrate is a light-emitting side. The display panel further includes a plurality of second microcapsules. The diameter of the second microcapsule is smaller than the diameter of the first microcapsule. The second microcapsule is filled with the electrophoretic particles. The second microcapsule is located in the capsule gap and on the side of the column facing away from the first substrate.

In some embodiments, a groove is defined in a side of the column facing away from the first substrate. The second microcapsule is partially located in the groove and abuts against a bottom of the groove.

In some embodiments, a diameter of the second microcapsule is X1, a depth of the groove along the first direction is X2, a height of the column along the first direction is X3, a diameter of the first microcapsule is X4, then X1−X2+X3=X4.

In some embodiments, a height of the column is equal to a diameter of the first microcapsule.

In some embodiments, the side of the second substrate facing away from the first substrate is a light-emitting side. The column includes a bottom surface, a side surface, and a top surface. The side surface is located between the bottom surface and the top surface, and the side surface is connected to the bottom surface and the top surface respectively along two sides in the first direction. The bottom surface is located on the side of the side surface facing the first substrate. The top surface is located on the side of the side surface facing the second substrate. The top surface is in the shape of an arc surface, and the top surface is convex toward the side facing away from the bottom surface.

In some embodiments, the interior of the column is hollow to form an accommodating cavity. The electrophoretic particles are located in the accommodating cavity. The shape of the accommodating cavity is conical, and along the first direction, a cross-sectional area of the accommodating cavity gradually increases.

The present application further discloses a method for manufacturing a display panel, which is used to prepare the display panel described above, the method including the following operations:
providing a first substrate;
forming an active switch layer on the first substrate;
forming a column on the active switch layer;
arranging a first microcapsule on the first substrate;
aligning and bonding the second substrate on the side of the first microcapsule and the column facing away from the first substrate;
wherein the interior of the first microcapsule is hollow and is filled with electrophoretic particles, and the interior of the column is hollow and is filled with electrophoretic particles.

In some embodiments, the operation of forming the column on the active switch layer includes:
forming a photocuring layer on the active switch layer;
photo-etching the photocuring layer to form a plurality of slot bodies with hollow interiors;
filling the slot bodies with the electrophoretic particles, and arranging an encapsulation layer at the openings of the slot bodies to form the columns.

The present application further discloses a display device and a display panel, wherein the display panel is connected to the driving circuit.

Compared with the display panel solution in which the electrophoretic layer only includes microcapsules, the present application adds a column in the electrophoretic layer. The column is located in the capsule gap created by the four adjacent first microcapsules. The column is filled with electrophoretic particles, which play the reflection role of the first microcapsule, thus avoiding the problem of failure to reflect light at the position of the display panel corresponding to the capsule gap, improving the brightness of the display panel and the display effect. Besides, the structural strength of the electrophoretic layer can be improved, and the display panel can be prevented from bending and deforming when it has a relatively large volume.

### BRIEF DESCRIPTION OF DRAWINGS

The accompanying drawings are used to provide a further understanding of the embodiments according to the present application, and constitute a part of the specification. They are used to illustrate the embodiments according to the present application, and explain the principle of the present application in conjunction with the text description. Apparently, the drawings in the following description merely represent some embodiments of the present disclosure, and for those having ordinary skill in the art, other drawings may also be obtained based on these drawings without investing creative efforts. Hereinafter the present application will be described in detail with reference to the accompanying drawings and optional embodiments.

FIG. 1 is a schematic diagram of a display device according to an embodiment of the present application.

FIG. 2 is a plan schematic diagram of a display panel according to a first embodiment of the present application.

FIG. 3 is a cross-sectional view of a display panel according to the first embodiment of the present application.

FIG. 4 is a schematic diagram of a concave portion according to the first embodiment of the present application.

FIG. 5 is a schematic diagram of a second microcapsule according to the first embodiment of the present application.

FIG. 6 is a schematic diagram of a groove according to the first embodiment of the present application.

FIG. 7 is a schematic diagram of a display panel according to a second embodiment of the present application.

FIG. 8 is a schematic diagram of a micro protrusion according to the second embodiment of the present application.

FIG. 9 is a schematic diagram of a column according to the second embodiment of the present application.

FIG. 10 is a schematic diagram of an accommodating cavity according to the second embodiment of the present application.

FIG. 11 is a schematic diagram of a method for manufacturing a display panel according to an embodiment of the present application.

FIG. 12 is a schematic diagram illustrating a process for manufacturing a display panel according to an embodiment of the present application.

FIG. 13 is a flowchart of a method for manufacturing a column according to an embodiment of the present application.

FIG. 14 is a schematic diagram illustrating a process of manufacturing column according to an embodiment of the present application.

In the drawings: 10, display device; 20, driving circuit; 30, display panel; 110, first substrate; 120, second substrate; 200, active switch layer; 210, pixel electrode layer; 220, common electrode layer; 230, thin film transistor; 300, electrophoretic layer; 310, first microcapsule; 320, second microcapsule; 330, capsule gap; 400, column; 410, bottom surface; 420, side surface; 430, top surface; 440, groove; 450, accommodating cavity; 460, micro protrusion; 500, electrophoretic particle; 610, protective layer; 620, optical adhesive layer; 700, refractive layer; 710, flat portion; 720, protruding portion; 730, concave portion; 810, photocuring layer; 820, slot body; 830, encapsulation layer.

### DETAILED DESCRIPTION OF EMBODIMENTS

It should be understood that the terms used herein, the specific structures and function details disclosed herein are intended for the mere purposes of describing specific embodiments and are representative. However, this application may be implemented in many alternative forms and should not be construed as being limited to the embodiments set forth herein.

As used herein, terms “first”, “second”, or the like are merely used for illustrative purposes, and shall not be construed as indicating relative importance or implicitly indicating the number of technical features specified. Thus, unless otherwise specified, the features defined by “first” and “second” may explicitly or implicitly include one or more of such features. Terms “multiple”, “a plurality of”, and the like mean two or more. Term “comprising”, “including”, and any variants thereof mean non-exclusive inclusion, so that one or more other features, integers, steps, operations, units, components, and/or combinations thereof may be present or added.

In addition, terms “center”, “transverse”, “up”, “down”, “left”, “right”, “vertical”, “horizontal”, “top”, “bottom”, “inside”, “outside”, or the like are used to indicate orientational or relative positional relationships based on those illustrated in the drawings. They are merely intended for simplifying the description of the present disclosure, rather than indicating or implying that the device or element referred to must have a particular orientation or be constructed and operate in a particular orientation. Therefore, these terms are not to be construed as restricting the present disclosure.

Furthermore, as used herein, terms “installed on”, “mounted on”, “connected to”, “coupled to”, “connected with”, and “coupled with” should be understood in a broad sense unless otherwise specified and defined. For example, they may indicate a fixed connection, a detachable connection, or an integral connection. They may denote a mechanical connection, or an electrical connection. They may denote a direct connection, a connection through an intermediate, or an internal connection between two elements. For those of ordinary skill in the art, the specific meanings of the above terms as used in the present application can be understood depending on specific contexts.

Hereinafter this application will be described in further detail with reference to the accompanying drawings and some optional embodiments.

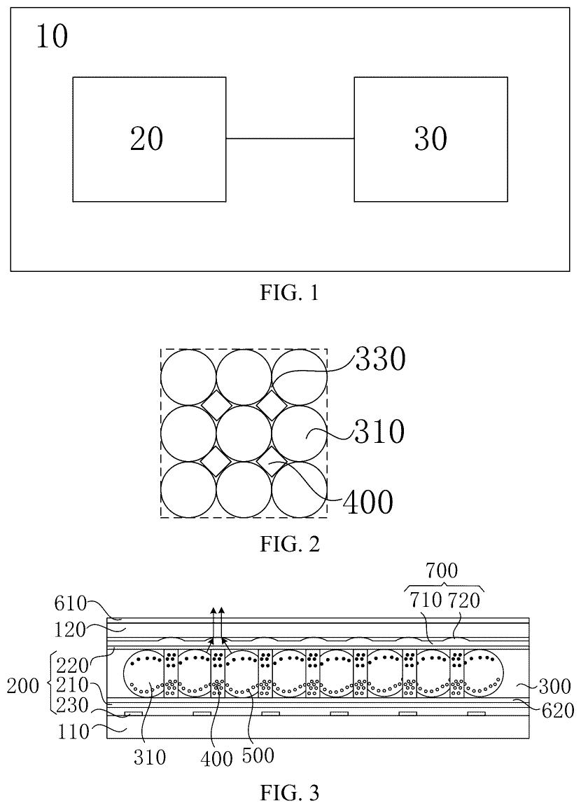

FIG. 1 is a schematic diagram of a display device according to an embodiment of the present application. As shown in FIG. 1, the present application provides a display device 10, including a driving circuit 20 and a display panel 30. The display panel 30 is connected to the driving circuit 20. The driving circuit 20 drives the display panel 30 to display an image. The display panel 30 is an electronic paper display panel 30.

The present application further discloses a display panel 30, which can be used in the display device 10 described above. For the display panel 30, the present application provides the following designs, which are specifically described through several embodiments as follows.

### Embodiment 1

FIG. 2 is a schematic plan view of a display panel according to the first embodiment of the present application. FIG. 3 is a schematic cross-sectional view of a display panel according to the first embodiment of the present application. As shown in FIGS. 2-3, the present application discloses a display panel 30. The display panel 30 includes a first substrate 110, an active switch layer 200, an electrophoretic layer 300, and a second substrate 120 arranged in sequence. The first substrate 110 includes a glass substrate. The second substrate 120 includes a PET (Polyethylene terephthalate) substrate.

The electrophoretic layer 300 is disposed between the first substrate 110 and the second substrate 120. The active switch layer 200 is disposed on the first substrate 110. The active switch layer 200 may be disposed on the side of the first substrate 110 facing away from the second substrate 120, or on the side of the first substrate 110 adjacent to the second substrate 120, which is not limited here.

The electrophoretic layer 300 includes a plurality of first microcapsules 310 and a plurality of columns 400. Each of the first microcapsules 310 is hollow inside and filled with electrophoretic particles 500. Each of the columns 400 is hollow inside and filled with electrophoretic particles 500. The electrophoretic particles 500 include black and white particles, or may be colored particles. The active switch layer 200 drives the electrophoretic particles 500 to move in the first microcapsules 310 and the columns 400.

The first microcapsule 310 is spherical. The plurality of first microcapsules 310 are arranged in a matrix. A capsule gap 330 is defined between four adjacent first microcapsules 310. The column 400 is located in the capsule gap 330. Let the direction pointing from the first substrate 110 to the second substrate 120 be a first direction, then a height direction of the column 400 is identical with the first direction.

The column 400 includes a cylinder and a prism. In this application, the side of the second substrate 120 facing away from the first substrate 110 is taken as a light-emitting side. Of course, the side of the first substrate 110 facing away from the second substrate 120 may an also be taken as the light-emitting side. In this application, the side of the second substrate 120 facing away from the first substrate 110 is taken as the light-emitting side as an example, that is, the side of the second substrate 120 is the side facing the user.

Compared with the display panel 30 in which the electrophoretic layer 300 only includes microcapsules, the present application adds a column 400 in the electrophoretic layer 300. The column 400 is located in the capsule gap 330 created by the four adjacent first microcapsules 310. The column 400 is filled with electrophoretic particles 500, which play the role of the first microcapsule 310, thus avoiding the problem of failure to reflect light at the position of the display panel 30 corresponding to the capsule gap 330, improving the brightness of the display panel 30 and the display effect.

Besides, since the column 400 is added in the electrophoretic layer 300, the structural strength of the electrophoretic layer 300 can be improved, and the display panel 30 can be prevented from bending and deforming when it has a relatively large volume.

The display panel 30 further includes a protective layer 610 and an optical adhesive layer 620. The protective layer 610 is disposed on a side of the second substrate 120 facing away from the first substrate 110. The protective layer 610 includes a release film. The optical adhesive layer 620 is disposed between the electrophoretic layer 300 and the active switch layer 200. The active switch layer 200 includes a thin film transistor 230, a pixel electrode layer 210, and a common electrode layer 220. The pixel electrode layer 210 is disposed on the side of the first substrate 110 facing the second substrate 120. The common electrode layer 220 is disposed on the side of the second substrate 120 facing the first substrate 110. The thin film transistor 230 is disposed on the side of the pixel electrode layer 210 facing away from the common electrode layer 220 and is connected to the pixel electrode layer 210. The thin film transistor 230 controls the generation of an electric field between the pixel electrode layer 210 and the common electrode layer 220 to drive the electrophoretic particles 500 to move.

As shown in FIG. 3, the directions indicated by the arrows in FIG. 3 are the propagation directions of part of the light rays. The display panel 30 further includes a refractive layer 700. The refractive layer 700 is disposed on the side of the electrophoretic layer 300 facing away from the first substrate 110. The refractive layer 700 includes a flat portion 710 and a protruding portion 720. A projection of the flat portion 710 on the first substrate 110 overlaps a projection of the respective first microcapsule 310 on the first substrate 110. A projection of the protruding portion 720 on the first substrate 110 overlaps a projection of the respective column 400 on the first substrate 110. The protruding portion 720 protrudes upward in the first direction.

That is, the protruding portion 720 is disposed corresponding to the position of the capsule gap 330. After the light is irradiated to the first microcapsules 310 around the capsule gap 330, part of the reflected light will be emitted from the first protruding portion 720, and the light will be scattered by the protruding portion 720, thereby improving the display brightness of the display panel 30 at the position corresponding to the capsule gap 330.

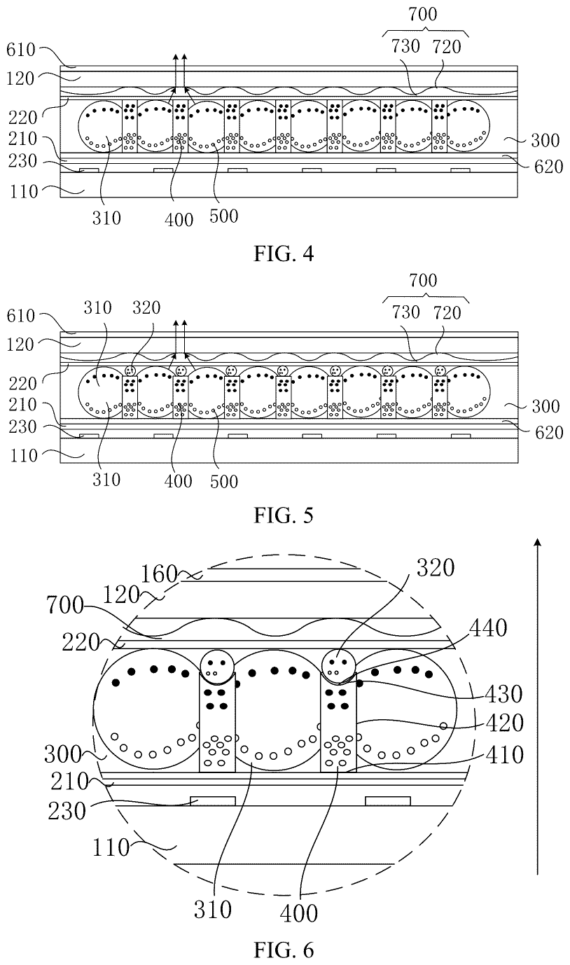

Further, a concave portion 730 may be provided in the refractive layer 700. FIG. 4 is a schematic diagram of a concave portion according to the first embodiment of the present application. As shown in FIG. 4, the directions indicated by the arrows in the FIG. are the propagation directions of part of the light rays. The refractive layer 700 includes a concave portion 730 and a protruding portion 720. A projection of the concave portion 730 on the first substrate 110 overlaps or coincides with a projection of the first microcapsule 310 on the first substrate 110. A projection of the protruding portion 720 on the first substrate 110 overlaps or coincides with a projection of the column 400 on the first substrate 110. The protruding portion 720 bulges upward in the first direction. The concave portion 730 is concave downward in an opposite direction to the first direction.

That is, the protruding portion 720 corresponds to the position of the capsule gap 330, and the concave portion 730 corresponds to the position of the first microcapsule 310. The light irradiated to the first microcapsule 310 passes through the concave portion 730, and part of the light is refracted to the position of the capsule gap 330, and is reflected by the column 400 and emitted from the protruding portion 720, further improving the display brightness of the display panel 30 at the position corresponding to the capsule gap 330.

FIG. 5 is a schematic diagram of a second microcapsule according to the first embodiment of the present application. As shown in FIG. 5, the display panel 30 further includes a plurality of second microcapsules 320. A diameter of the second microcapsule 320 is smaller than a diameter of the first microcapsule 310. The second microcapsule 320 is filled with the electrophoretic particles 500. The second microcapsule 320 is located in the capsule gap 330 and is disposed on the side of the column 400 facing away from the first substrate 110.

The diameter of the second microcapsule 320 plus the height of the column 400 is equal to the diameter of the first microcapsule 310. That is, it can be understood that the second microcapsule 320 is a single-layer arrangement, and there can be one second microcapsule 320 or multiple tiled second microcapsules 320 in one capsule gap 330, which is not limited here.

Since the capsule gap 330 has a small space, if the second microcapsules 320 with a smaller diameter is directly filled in the capsule gap 330, multiple layers of second microcapsules 320 will appear in the capsule gap 330, and the second microcapsules 320 will move randomly in the capsule gap 330, resulting in uneven reflection of light after entering the capsule gap 330 through the second microcapsules 320, thereby affecting the display effect of the display panel 30.

Therefore, in this embodiment, the column 400 is first arranged in capsule gap 330, and second microcapsule 320 is then arranged on the column 400, so that no extra second microcapsules 320 are required to save costs, and second microcapsules 320 can be ensured not to move arbitrarily in capsule gap 330, thereby avoiding the situation where light cannot be reflected.

FIG. 6 is an enlarged schematic diagram of a groove according to the first embodiment of the present application. As shown in FIG. 6, the direction indicated by the arrow in the FIG. is the first direction. In this embodiment, a groove 440 is further defined in the side of the column 400 facing away from the first substrate 110. The second microcapsule 320 is partially disposed in the groove 440 and abuts against the bottom of the groove 440.

The groove 440 limits the second microcapsule 320, thereby preventing the second microcapsule 320 from moving horizontally in the capsule gap 330. When a plurality of second microcapsules 320 are arranged in a single capsule gap 330, the number of the corresponding grooves 440 and the number of the second microcapsules 320 may correspond one to one.

Further, the diameter of the second microcapsule 320 is X1, the depth of the groove 440 along the first direction is X2, the height of the column 400 along the first direction is X3, and the diameter of the first microcapsule 310 is X4, then X1−X2+X3=X4. Since the shape of the second microcapsule 320 is also spherical, the side facing the second substrate 120 is a curved surface, which is similar to the curvature of the side of the first microcapsule 310 facing the second substrate 120, thereby ensuring that the reflection effect of the second microcapsule 320 on light is identical with that of the first microcapsule 310 on light.

### Embodiment 2

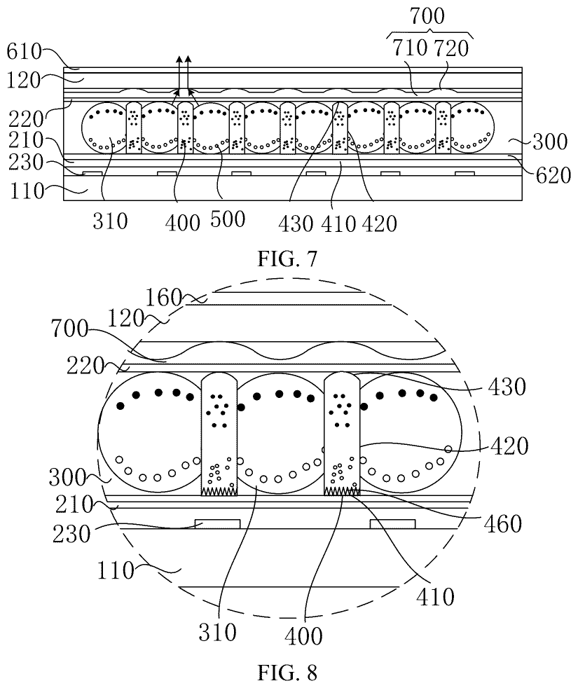

FIG. 7 is a schematic diagram of a display panel according to a second embodiment of the present application. As shown in FIG. 7, unlike the first embodiment, the second capsule is not disposed on the column 400 in the present embodiment. Specifically, the height of the column 400 is equal to the diameter of the first microcapsule 310.

It can avoid the problem that the reflected light irradiated on the column 400 is absorbed by the surrounding first microcapsules 310 when the height of the column 400 is less than the height of the first microcapsule 310. It can also prevent the difference between the distance from the light reflected on the column 400 to the user and the distance from the light reflected on the first microcapsule 310 to the user when the height of the column 400 is less than the height of the first microcapsule 310. That is, it avoids the difference between the reflection of light by the column 400 at the capsule gap 330 and the reflection of light by the first microcapsule 310, thereby improving the image display effect.

Compared with the solution of the first embodiment, the second microcapsule 320 is not required in this embodiment, which can save process, save cost, and improve production efficiency.

Furthermore, in order to reduce the difference between the reflection of light by the column 400 and the reflection of light by the first microcapsule 310, the present embodiment further sets the side of the column 400 facing the second substrate 120 as a curved surface, as follows.

The side of the second substrate 120 facing away from the first substrate 110 is a light-emitting side. The column 400 includes a bottom surface 410, a side surface 420, and a top surface 430. The side surface 420 is located between the bottom surface 410 and the top surface 430, and the side surface 420 is connected to the bottom surface 410 and the top surface 430 along both sides in the first direction. The bottom surface 410 is located on the side of the side surface 420 facing the first substrate 110. The top surface 430 is located on the side of the side surface 420 facing the second substrate 120. The top surface 430 is in the shape of an arc surface. The top surface 430 is convex toward the side facing away from the bottom surface 410.

The curvature of the top surface 430 is similar to that of the first microcapsule 310, so that the light reflection path of the entire display panel 30 is the same at any position, avoiding the occurrence of planar reflection when the light is irradiated on the column 400 and curved reflection when the light is irradiated on the first microcapsule 310, thereby balancing the brightness difference at different positions of the display panel 30 while improving the display brightness of the display panel 30.

FIG. 8 is a schematic diagram of a micro protrusion according to the second embodiment of the present application. As shown in FIG. 8, since the electrophoretic particles 500 are prone to agglomeration and sinking, which leads to the problem that the movement of the electrophoretic particles 500 cannot be controlled, the present embodiment further arranges a micro protrusion 460 in the column 400. Specifically, the interior of the column 400 is hollow, and the bottom surface 410, the side surface 420, and the top surface 430 of the column 400 jointly define an accommodating cavity 450. The electrophoretic particles 500 are located in the accommodating cavity 450. The column 400 further includes a plurality of micro protrusions 460. The plurality of micro protrusions 460 are arranged on the side of the bottom surface 410 facing the top surface 430.

When the electrophoretic particles 500 aggregate and sink, the multiple micro protrusions 460 of the bottom surface 410 can disperse the aggregated and sunken electrophoretic particles 500, thereby improving the life of the display panel 30 and avoiding the situation where the electrophoretic particles 500 aggregate and sink and become unusable.

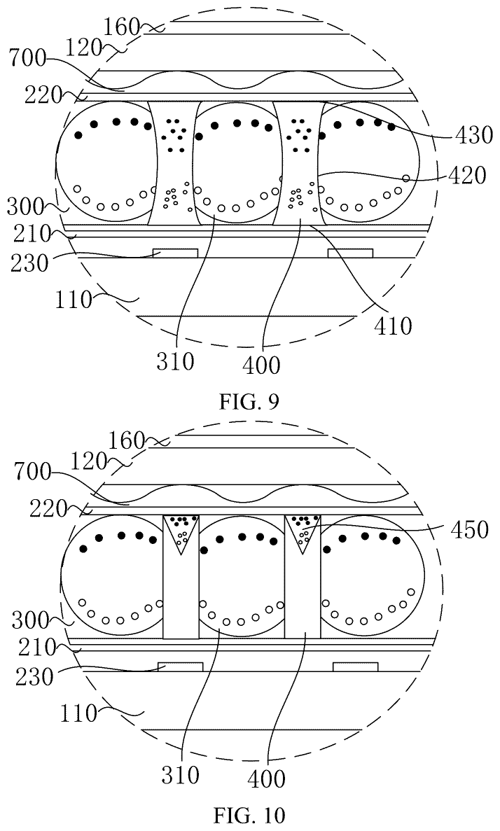

FIG. 9 is a schematic diagram of a column according to the second embodiment of the present application. As shown in FIG. 9, since the first microcapsule 310 is spherical and the upper half of the first microcapsule 310 is a curved surface, the distance from the middle area of the upper half of the first microcapsule 310 to the second substrate is different than the distance from the peripheral area of the upper half of the same first microcapsule 310 to the second substrate 120, resulting in that the light may not be directly reflected upward when it is irradiated on the peripheral area of the first microcapsule 310.

Therefore, in this embodiment, the side surface 420 of the column 400 may also be made into a curved surface. Specifically, the side surface 420 of the column 400 abuts against the four adjacent first microcapsules 310. Furthermore, the cross-sectional area of the column 400 along the first direction first decreases and then increases. A projection of the top surface 430 of the column 400 on the first substrate 110 partially overlaps a projection of the first microcapsule 310 on the substrate. That is, the side surface 420 of the column 400 is concave toward the direction of a central axis of the column 400, and the column 400 has a structure that is thin in the middle and wide at both ends.

The top surface 430 of the column 400 can cover the entire capsule gap 330 area as much as possible, and can also cover part of the upper half of the first microcapsule 310 that is relatively farther away from the second substrate 120, that is, the peripheral area of the upper half of the first microcapsule 310. This can not only improve the display brightness of the entire display panel 30, but also make the reflection surface of the electrophoretic layer 300 of the entire display panel 30 tend to be a plane, thereby improving the display effect.

FIG. 10 is a schematic diagram of an accommodating cavity according to the second embodiment of the present application. As shown in FIG. 10, the present application further sets the shape of the accommodating cavity 450 to be conical. Specifically, the shape of the accommodating cavity 450 is conical, and along the first direction, the cross-sectional area of the accommodating cavity 450 gradually increases. That is, the accommodating cavity 450 is in an inverted cone shape, so that the number of electrophoretic particles 500 disposed in the column 400 can be reduced, thereby reducing the manufacturing cost.

Furthermore, setting the accommodating cavity 450 to be conical can also reduce the moving path of the electrophoretic particles 500 and increase the reaction speed of the electrophoretic particles 500 in the column 400, thereby achieving the effect of reducing energy consumption.

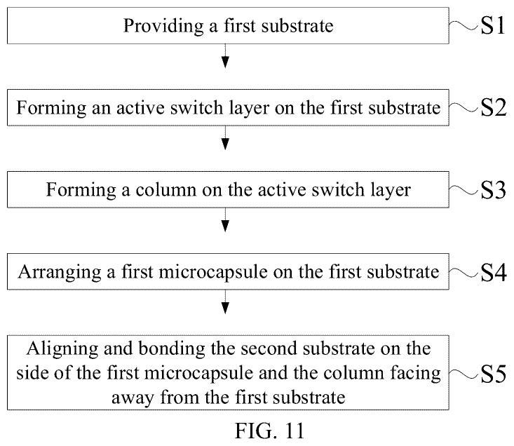

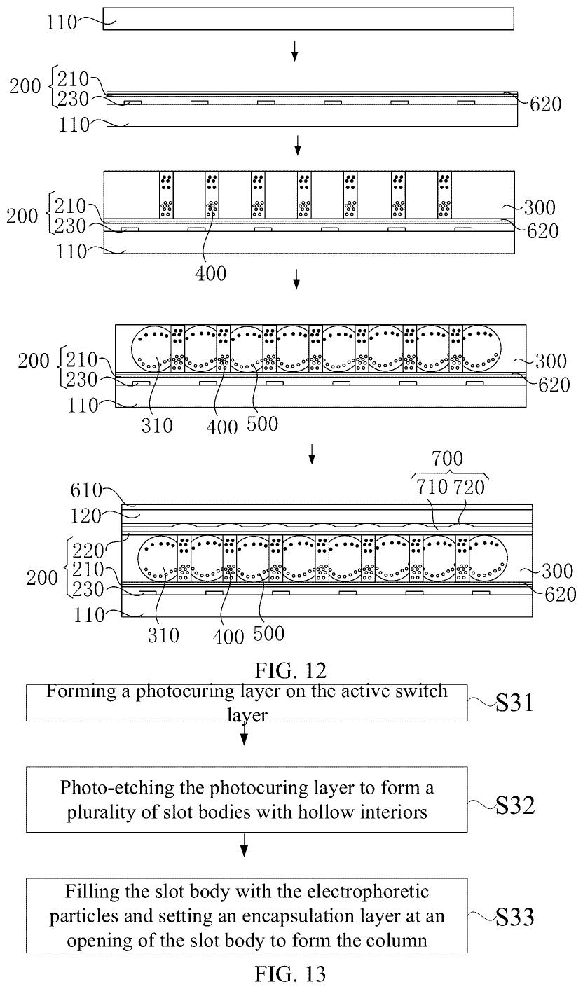

FIG. 11 is a schematic diagram of a method for manufacturing a display panel according to an embodiment of the present application. FIG. 12 is a schematic diagram of a process for manufacturing a display panel according to an embodiment of the present application. As shown in FIG. S. 11-12, the present application further discloses a method for manufacturing a display panel 30, which is used for the display panel 30 described in the above embodiments, the method including the following operations:
S1: providing a first substrate;
S2: forming an active switch layer on the first substrate;
S3: forming a column on the active switch layer;
S4: arranging a first microcapsule on the first substrate;
S5: aligning the second substrate on the side of the first microcapsule and the column facing away from the first substrate;
wherein the interior of the first microcapsule 310 is hollow and filled with electrophoretic particles 500, and the interior of the column 400 is hollow and filled with electrophoretic particles 500.

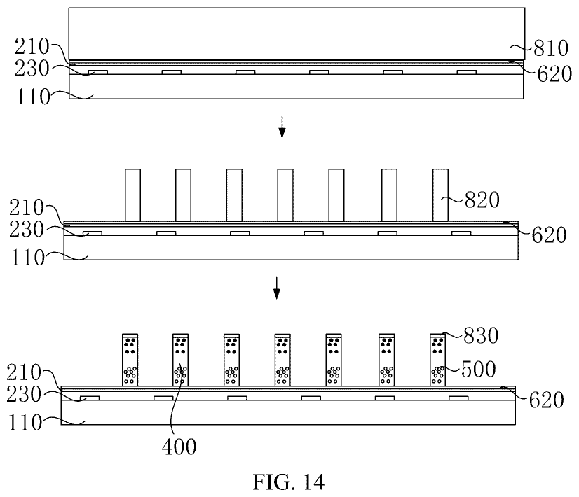

FIG. 13 is a schematic diagram of a method for manufacturing a column according to an embodiment of the present application. FIG. 14 is a schematic diagram of a process for manufacturing a column according to an embodiment of the present application. As shown in FIG. 10-14, the operation of forming the column on the active switch layer in S3 includes:
S31: forming a photocuring layer on the active switch layer;
S32: photo-etching the photocuring layer to form a plurality of slot bodies with hollow interiors;
S33: filling the slot body with the electrophoretic particles and setting an encapsulation layer at an opening of the slot body to form the column.

Specifically, a photocuring layer 810 is firstly arranged on the side of the pixel electrode layer 210 facing away from the first substrate 110, and then the photocuring layer 810 is photo-etched using a mask to form a plurality of slot bodies 820 with hollow interiors, and then the slot bodies 820 are filled with electrophoretic particles 500, and an encapsulation layer 830 is arranged at the opening of each of the slot bodies 820 to complete the arrangement of the column 400, thereby resulting in a simpler manufacturing process.

Compared with the display panel 30 in which the electrophoretic layer 300 only includes microcapsules, the present application adds a column 400 in the electrophoretic layer 300. The column 400 is located in the capsule gap 330 created by the four adjacent first microcapsules 310. The column 400 is filled with electrophoretic particles 500, which play the role of the first microcapsule 310, thus avoiding the problem of failure to reflect light at the position of the display panel 30 corresponding to the capsule gap 330, improving the brightness of the display panel 30 and the display effect. Besides, since the column 400 is added in the electrophoretic layer 300, the structural strength of the electrophoretic layer 300 can be improved, and the display panel 30 can be prevented from bending and deforming when it has a relatively large volume.

It should be noted that the limitations of various operations involved in this solution will not be deemed to limit the order of the operations, provided that they do not affect the implementation of the specific solution, so that the operations written earlier may be executed earlier or they may also be executed later or even at the same time. As long as the solution can be implemented, they should all be regarded as falling in the scope of protection of this application.

It should be noted that the inventive concept of the present application can be formed into many embodiments, but the length of the application document is limited and so these embodiments cannot be enumerated one by one. The technical features can be arbitrarily combined to form a new embodiment, and the original technical effect may be enhanced after the various embodiments or technical features are combined.

The foregoing description is merely a further detailed description of the present application made with reference to some specific illustrative embodiments, and the specific implementations of the present application will not be construed to be limited to these illustrative embodiments. For those having ordinary skill in the technical field to which this application pertains, numerous simple deductions or substitutions may be made without departing from the concept of this application, which shall all be regarded as falling in the scope of protection of this application.

What is claimed is:

1. A display panel, comprising:
a first substrate;
an active switch layer;
an electrophoretic layer;
a second substrate; wherein the first substrate, the active switch layer, the electrophoretic layer, and the second substrate are arranged in sequence, wherein the electrophoretic layer is arranged between the first substrate and the second substrate;
wherein the active switch layer is arranged on the first substrate; wherein the electrophoretic layer comprises a plurality of first microcapsules and a plurality of columns; wherein an interior of each of the plurality of first microcapsules is hollow and filled with a plurality of electrophoretic particles; wherein an interior of each of the plurality of columns is hollow and filled with a plurality of electrophoretic particles; wherein each of the plurality of first microcapsules is spherical; wherein the plurality of first microcapsules are arranged in a matrix, wherein there is defined a capsule gap between every four adjacent first microcapsules, and the respective column is disposed in the capsule gap; wherein let a direction pointing from the first substrate toward the second substrate be a first direction, wherein a height direction of each of the plurality of columns is consistent with the first direction; wherein a side of the second substrate facing away from the first substrate is a light-emitting side; and
a plurality of second microcapsules, wherein a diameter of each of the plurality of second microcapsules is less than a diameter of each of the plurality of first microcapsules, wherein each of the plurality of second microcapsules is filled with the electrophoretic particles; wherein each of the plurality of second microcapsules is disposed in the respective capsule gap and on a side of the respective column facing away from the first substrate.

2. The display panel as recited in claim 1, wherein a diameter of each of the plurality of second microcapsules plus a height of the respective column is equal to a diameter of each of the plurality of first microcapsules.

3. The display panel as recited in claim 1, wherein there is defined a groove in a side of each of the plurality of columns facing away from the first substrate, and wherein the respective second microcapsule is partially disposed in the groove and abuts against a bottom of the groove.

4. The display panel as recited in claim 3, wherein let a diameter of each of the plurality of second microcapsules be X1, a depth of the respective groove along the first direction be X2, a height of the respective column along the first direction is X3, and a diameter of each of the plurality of first microcapsules be X4, then the following equation is met: X1−X2+X3=X4.

5. The display panel as recited in claim 4, wherein there is arranged a plurality of second microcapsules in each single capsule gap, and wherein a number of the grooves is in one-to-one correspondence with a number of the plurality of second microcapsules arranged in the capsule gap.

6. The display panel as recited in claim 1, wherein there is arranged one second microcapsule in each capsule gap.

7. The display panel as recited in claim 1, wherein there is arranged a plurality of the second microcapsules that are laid out in each capsule gap.

8. The display panel as recited in claim 1, further comprising a refractive layer arranged on a side of the electrophoretic layer facing away from the first substrate, wherein the refractive layer comprises a flat portion and a protruding portion, wherein a projection of the flat portion on the first substrate overlaps or coincides with a projection of the respective first microcapsule on the first substrate, wherein a projection of the protruding portion on the first substrate overlaps or coincides with a projection of the respective column on the first substrate, wherein the protruding portion protrudes upward along the first direction.

9. The display panel as recited in claim 1, further comprising a refractive layer, which is arranged on a side of the electrophoretic layer facing away from the first substrate, wherein the refractive layer comprises a concave portion and a protruding portion, wherein a projection of the concave portion on the first substrate overlaps or coincides with a projection of the respective first microcapsule on the first substrate, wherein a projection of the protruding portion on the first substrate overlaps or coincides with a projection of the respective column on the first substrate, wherein the protruding portion bulges upward along the first direction, wherein the concave portion is concave downward in a direction opposite to the first direction.

10. The display panel as recited in claim 1, wherein the electrophoretic layer is disposed between the first substrate and the second substrate, wherein the active switch layer is disposed on the first substrate, and wherein the active switch layer is disposed on a side of the first substrate facing away from the second substrate.

11. The display panel as recited in claim 1, wherein the display panel further comprises a protective layer and an optical adhesive layer, wherein the optical adhesive layer is arranged between the electrophoretic layer and the active switch layer, wherein the protective layer is arranged on a side of the second substrate facing away from the first substrate, wherein the protective layer comprises a release film.

12. The display panel as recited in claim 1, wherein the active switch layer comprises a thin film transistor, a pixel electrode layer, and a common electrode layer; wherein the pixel electrode layer is disposed on a side of the first substrate facing the second substrate, wherein the common electrode layer is disposed on a side of the second substrate facing the first substrate; wherein the thin film transistor is disposed on a side of the pixel electrode layer facing away from the common electrode layer and is connected to the pixel electrode layer, wherein the thin film transistor is used to control an electric field to be generated between the pixel electrode layer and the common electrode layer to drive the plurality of electrophoretic particles to move.

13. The display panel as recited in claim 1, wherein the plurality of electrophoretic particles comprise black and white particles.

14. The display panel as recited in claim 1, wherein the plurality of electrophoretic particles comprise colored particles.

15. The display panel as recited in claim 1, wherein each of the plurality of columns has a shape that comprises a cylinder and a prism.

16. A display device, comprising a driving circuit and a display panel connected to the driving circuit, wherein the display panel comprises:
a first substrate;
an active switch layer;
an electrophoretic layer;
a second substrate; wherein the first substrate, the active switch layer, the electrophoretic layer, and the second substrate are arranged in sequence, wherein the electrophoretic layer is arranged between the first substrate and the second substrate;
wherein the active switch layer is arranged on the first substrate; wherein the electrophoretic layer comprises a plurality of first microcapsules and a plurality of columns; wherein an interior of each of the plurality of first microcapsules is hollow and filled with a plurality of electrophoretic particles; wherein an interior of each of the plurality of columns is hollow and filled with a plurality of electrophoretic particles; wherein each of the plurality of first microcapsules is spherical; wherein the plurality of first microcapsules are arranged in a matrix, wherein there is defined a capsule gap between every four adjacent first microcapsules, and the respective column is disposed in the capsule gap; wherein let a direction pointing from the first substrate toward the second substrate be a first direction, wherein a height direction of each of the plurality of columns is consistent with the first direction; wherein a side of the second substrate facing away from the first substrate is a light-emitting side; and
a plurality of second microcapsules, wherein a diameter of each of the plurality of second microcapsules is less than a diameter of each of the plurality of first microcapsules, wherein each of the plurality of second microcapsules is filled with the electrophoretic particles; wherein each of the plurality of second microcapsules is disposed in the respective capsule gap and on a side of the respective column facing away from the first substrate.
